(19) United States
(12) Patent Application Publication
(10) Pub. No.: US 2026/0188781 A1
(43) Pub. Date: Jul. 2, 2026

(54) TEMPERATURE-CONTROL ELEMENT AND TRACTION BATTERY

(71) Applicant: KAUTEX TEXTRON GmbH & Co. KG, Bonn (DE)

(72) Inventors: Moritz Lipperheide, Bonn (DE); Erik Elbaek, Mainz-Kastel (DE)

(21) Appl. No.: 18/728,213

(22) PCT Filed: Dec. 13, 2022
(86) PCT No.: PCT/EP2022/085554

§ 371 Date: Jul. 11, 2024

(30) Foreign Application Priority Data
Jan. 11, 2022 (DE) 10 2022 100 542.9

(51) Int. Cl. H01M 10/6556; H01M 10/613; H01M 10/617; H01M 10/625; H01M 10/653; H01M 10/6551

(52) U.S. Cl. CPC H01M 10/6556; H01M 10/613; H01M 10/617; H01M 10/625; H01M 10/653; H01M 10/6551

(57) ABSTRACT

A temperature-control element for controlling the temperature of a traction battery, having: a feed and a return for a heat transfer medium for connecting the temperature-control element to a temperature-control device, and at least two temperature-control zones through which a fluid can flow, each temperature-control zone being fluidically connected to the feed via a feed channel and to the return via a return channel. The temperature-control element has at least one flow divider which is arranged in the feed channel and divides the feed channel into a first feed channel and a second feed channel. At least a first temperature-control zone is fluidically connected to the first feed channel; and at least one second temperature-control zone is fluidically connected to the second feed channel.

The invention relates to a temperature-control element and to a traction battery.

Battery modules of a traction battery for motor vehicles can be temperature controlled. This can prevent overheating of a battery module and/or set a favorable temperature in the battery module.

Various devices and methods are known in the prior art for controlling the temperature of a battery module.

The object of the invention is that of providing an improvement over or an alternative to the prior art.

According to a first aspect of the invention, the object is achieved by a temperature-control element for controlling the temperature of a traction battery, having:
a feed and a return for a heat transfer medium for connecting the temperature-control element to a temperature-control device,
at least two temperature-control zones through which a fluid can flow, wherein each temperature-control zone is fluidically connected to the feed via a feed channel and to the return via a return channel,
wherein the temperature-control element has at least one flow divider which is arranged in the feed channel and divides the feed channel into a first feed channel and a second feed channel;
wherein at least a first temperature-control zone is fluidically connected to the first feed channel; and
wherein at least one second temperature-control zone is fluidically connected to the second feed channel.

In this regard, the following is explained conceptually:
It is first expressly noted that, in the context of the present patent application, indefinite articles and numbers such as “one,” “two,” etc., should generally be understood as being “at least” statements, i.e., as “at least one . . . ,” “at least two . . . ,” etc., unless it is clear from the relevant context or it is obvious or technically compelling to a person skilled in the art that only “exactly one . . . ,” “exactly two . . . ,” etc., may be meant.

In the context of the present patent application, the expression “in particular” is always to be understood in such a way that an optional, preferred feature is introduced with this expression. The expression is not to be understood as “specifically” and not as “namely.”

A “traction battery” is understood to be an energy storage device, in particular an energy storage device for electrical power. A traction battery is preferably suitable for installation in and for driving electric cars.

A “battery module” is understood to mean a component of a traction battery, wherein the battery module has a plurality of battery cells for storing electrical energy on an electrochemical basis. A battery module can be an assembly that can be accommodated independently in the traction battery and can be electrically and/or mechanically connected to other components of the traction battery.

A “temperature-control element” is understood to mean a device through which a fluid can flow, which is designed as a component of a traction battery for controlling the temperature of, in particular for cooling and/or heating, at least one battery cell and/or at least one battery module, in particular for cooling and/or heating exactly two battery modules, exactly three battery modules, exactly four battery modules, exactly five battery modules, or more than five battery modules. Preferably, the temperature-control performance required by a designated battery cell and/or a designated battery module is provided by means of a designated temperature-control device and transported into or out of the temperature-control element by a heat transfer medium.

Preferably, the temperature-control element is a separate component or a separate assembly of the traction battery, which is configured to be accommodated in a battery housing of the traction battery. The temperature-control element can be arranged within the battery housing below the at least one battery module. In another preferred embodiment, the temperature-control element is arranged within the battery housing above the at least one battery module.

The temperature-control element is configured to function as a component of a temperature-control circuit, wherein the temperature-control element can be connected to a designated temperature-control device by means of a feed and a return to the temperature-control circuit. The feed is configured to allow a heat transfer medium to flow from the designated temperature-control device into the temperature-control element. The return is configured to allow the heat transfer medium to flow from the temperature-control element back to the temperature-control device. Preferably, the feed and the return are designed as double nipples which are configured to be guided through a wall of a designated battery housing so that any detachable fluid connections are arranged outside the designated battery housing; potential leaks within the designated battery housing can thus be avoided.

A “temperature-control device” is understood to mean a device that is configured for a heat exchange between the heat transfer medium and the environment of a designated traction battery, in particular of a motor vehicle.

The temperature-control device can be configured to cause and/or maintain a temperature of at least one battery module, which is designated to be in operative connection with the temperature-control device via the temperature-control element and the heat transfer medium.

For this purpose, the temperature-control device can have a temperature control and/or a temperature regulation.

A “heat transfer medium” should be understood to mean, in particular, a gaseous and/or liquid substance or a gaseous and/or liquid mixture of substances which can be used to transport thermal energy and/or cooling energy by means of a volume flow of the heat transfer medium.

The temperature-control element as an assembly can consist of a plurality of components which can be connected to one another such that the temperature-control element is fluid-tight between the feed and the return. In particular, the temperature-control element can have a temperature-control element base and a temperature-control element cover. For this purpose, the temperature-control element can be welded and/or soldered and/or glued all around. The temperature-control element can have cooling fins. The cooling fins can be inserted between the temperature-control element base and the temperature-control element cover or can be connected to the temperature-control element base and/or the temperature-control element cover.

The temperature-control element has at least two temperature-control zones through which a fluid can flow. A “temperature-control zone” is a geometrically defined region of a temperature-control element which is configured for heat exchange with exactly one battery module, i.e., for cooling or heating the designated, correspondingly arranged battery module.

A temperature-control element can have exactly two temperature-control zones, exactly three temperature-control zones, exactly four temperature-control zones, exactly five temperature-control zones, or more than five temperature-control zones. It should be expressly noted that the number of a respective temperature-control zone does not have to be related to a position of this temperature-control zone within the temperature-control element. Rather, the sequence of temperature-control zones within a temperature-control element cannot be arranged in an ascending order.

Each temperature-control zone is preferably via exactly one feed channel indirectly fluidically connected to the feed of the temperature-control element. Each temperature-control zone is preferably via exactly one return channel indirectly fluidically connected to the return of the temperature-control element.

A “feed channel” is understood to mean the at least indirect fluid connection between the feed of the temperature-control element and exactly one temperature-control zone of the temperature-control element, or the connection between a flow divider and a flow divider arranged downstream in the direction of the designated fluid volume flow of the heat transfer medium. Preferably, a feed channel extends from a flow divider to a temperature-control zone or from a flow divider to a downstream flow divider, i.e., in particular from a first flow divider to a second flow divider or from a second flow divider to a third flow divider or from a third flow divider to a fourth flow divider.

A feed channel can be directly fluidically connected to exactly one or a plurality of temperature-control zones. For example, a first temperature-control zone and a second temperature-control zone can preferably be directly fluidically connected to the first feed channel.

If a feed channel is not provided with a number, i.e., if the feed channel is not referred to as first feed channel or second feed channel or the like, but only as feed channel, then this is the common feed channel to which all temperature-control zones of the temperature-control element are at least indirectly fluidically connected and which is arranged between the feed and the first flow divider.

A temperature-control element can have exactly one first and exactly one second feed channel. The temperature-control element can have exactly three feed channels, preferably exactly four feed channels, exactly five feed channels, exactly six feed channels, exactly seven feed channels, exactly eight feed channels, or more than eight feed channels.

A “return channel” is understood to mean the at least indirect fluid connection between the return of the temperature-control element and exactly one temperature-control zone of the temperature-control element, or the connection between a flow inlet and a flow inlet arranged downstream in the direction of the designated fluid volume flow of the heat transfer medium. A return channel preferably extends from a temperature-control zone to a flow inlet or from a flow inlet to a downstream flow inlet, i.e., in particular from a second flow inlet to a first flow inlet or from a third flow inlet to a second flow inlet or from a fourth flow inlet to a third flow inlet.

A return channel can be directly fluidically connected to exactly one or a plurality of temperature-control zones. For example, a first temperature-control zone and a second temperature-control zone can preferably be directly fluidically connected to the first return channel.

If a return channel is not provided with a number, i.e., if the return channel is not referred to as first return channel or second return channel or the like, but only as return channel, then this is the common return channel to which all temperature-control zones of the temperature-control element are at least indirectly fluidically connected and which is arranged between the return and the first flow inlet.

A temperature-control element can have exactly one first and exactly one second return channel. The temperature-control element can have exactly three return channels, preferably exactly four return channels, exactly five return channels, exactly six return channels, exactly seven return channels, exactly eight return channels, or more than eight return channels.

Preferably, a temperature-control zone of the temperature-control element has an outer surface for resting, at least in regions, against a battery module, preferably for fully resting against a battery module, wherein the outer surface is configured for heat transfer between the battery module and the temperature-control zone, i.e., for cooling or heating the designated, correspondingly arranged battery module.

Preferably, a temperature-control zone has cooling fins in its interior through which the heat transfer medium flows. The cooling fins can be arranged so as to correspond to a contact surface of a designated battery module.

A “flow divider” is understood to mean a geometric structure which is configured to divide a fluid volume flow flowing towards the flow divider, in particular a fluid volume flow of a heat transfer medium, into a first partial fluid volume flow and a second partial fluid volume flow. Preferably, a flow divider, in particular a first flow divider, is configured to divide a fluid volume flow of the heat transfer medium flowing in through the feed into a first partial fluid volume flow of the heat transfer medium flowing out through a first feed channel and a second partial fluid volume flow of the heat transfer medium flowing out through a second feed channel.

The term “fluidically connected” means that a heat transfer medium can be exchanged between parts and/or components of the temperature-control element, which are fluidically connected to one another, and flows between the fluidically connected parts and/or components if there is a designated difference in differential pressure between the feed and return of the temperature-control element.

A temperature-control element can have exactly one flow divider, preferably exactly two flow dividers, exactly three flow dividers, exactly four flow dividers, or more than four flow dividers.

The first temperature-control zone can be fluidically connected to the first feed channel. The second temperature-control zone can be fluidically connected to the second feed channel.

The main task of a temperature-control element of a traction battery is to uniformly control the temperature of the battery modules in a traction battery and/or the battery cells arranged in a battery module. The temperature-control element is, in particular, intended to keep the maximum temperature difference between two battery modules and/or two battery cells as low as possible, while at the same time complying with existing operating temperature limits.

In the fluid system of a temperature-control element consisting of a feed, a return, at least one flow divider, at least a first feed channel and a second feed channel, and at least two temperature-control zones, a small temperature difference between battery modules with the same thermal load can be achieved by evenly distributing the partial fluid volume flows of the heat transfer medium, divided by at least one flow divider, between the temperature-control zones, in particular if the battery modules and the temperature-control zones each have the same design.

This makes it possible to ensure that the heat transfer between the battery module and the temperature-control zone is the same for a plurality of designated pairings consisting of one battery module and one temperature-control zone each, so that a homogeneous temperature of the battery modules is achieved when the thermal load on the battery modules is uniform.

It should be expressly noted that the above applies both to cooling the battery modules and to heating the battery modules, in particular before charging the battery modules or before operating a designated motor vehicle.

An equal distribution of the partial fluid volume flows can be achieved if the sum of the pressure losses between the feed and the return of the temperature-control element acting upon a partial fluid volume flow designated to flow through a temperature-control zone is equal to the sum of the pressure losses between the feed and the return of the temperature-control element acting upon another partial fluid volume flow designated to flow through another temperature-control zone.

In case of more than two temperature-control zones, a uniform temperature-control performance of the respective battery modules can be achieved if the pressure losses between the feed and the return effective for a partial fluid volume flow through a temperature-control zone are equal. In other words, a uniform temperature-control performance can be achieved by the temperature-control element if the flow resistance acting upon designated flow tubes, which each extend through different temperature-control zones, is the same and/or if the summed pressure losses between the feed and the return acting upon the designated flow tubes are the same.

Passive measures which ensure that a plurality of temperature-control zones of a temperature-control element have an essentially identical designated partial fluid volume flow and thus an essentially identical temperature-control performance at the same design pressure difference of a designated heat transfer medium between the feed and the return of the temperature-control element are also understood as the hydraulic balancing of a temperature-control element. This can advantageously ensure that there is no inhomogeneous distribution of the temperature-control performance in the temperature-control element.

The pressure losses, acting upon the designated fluid volume flow of the heat transfer medium, and thus the designated partial fluid volume flows of the heat transfer medium and the heat flows in the temperature-control zones are essentially determined by the internal geometry of the temperature-control element.

The running lengths through the temperature-control element, which individual partial fluid volume flows of the heat transfer medium are designated to cover, as well as the cross-sections of the regions of the temperature-control element passed by the partial fluid volume flows vary for different temperature-control zones. Therefore, in order to achieve a homogeneous temperature-control performance or a hydraulic balancing of different temperature-control zones, geometric measures must be taken that lead to a homogeneous total pressure loss on the designated flow tubes through the respective temperature-control zones between the feed and the return.

In the prior art, it is known that a temperature-control element has a throttle which is operatively connected to a temperature-control zone, in particular operatively connected to exactly one temperature-control zone. This creates a merely locally pronounced bottleneck for a partial fluid volume flow with a corresponding nominal width of the throttle. The partial fluid volume flow which is designated to flow through the temperature-control zone corresponding to the throttle must also flow through the corresponding throttle. In order to achieve hydraulic balancing, the respective nominal width of a throttle is calculated and taken into account when manufacturing a temperature-control element.

A disadvantage here is that a nominal width of a throttle for a homogeneous temperature-control performance of the temperature-control element is subject to very high demands upon manufacturing tolerances, in particular because of the only small extension of the throttle in the designated flow direction of the corresponding designated partial fluid volume flow. Even minor deviations of the manufactured nominal width from the target nominal width can lead to comparatively large differences in pressure loss and therefore have an extremely sensitive effect on the homogeneous temperature-control performance of the temperature-control element. Tests have shown that even small deviations in the nominal width in the range of 0.1 mm can lead to a pressure difference of 2,000 Pa.

Furthermore, a hydraulic balancing achieved by means of one or more throttles has a detrimental effect on the space required for such a guidance of the designated heat transfer medium through the temperature-control element. Due to the high grade of packaging in a battery housing of a traction battery, the feed channel and the return channel of the temperature-control element are also positioned below the respective battery modules, and thus also contribute to the temperature control of the battery modules. When using a throttle for hydraulic balancing, it is essential to provide for constricting and widening regions in the guidance of the designated heat transfer medium, so that comparatively larger regions arise where the contact area of a battery module cannot correspond in the vertical direction with the heat transfer medium. This promotes temperature inhomogeneity of the designated traction battery and creates so-called hot spots at the battery modules.

Deviating from this, a temperature-control element is proposed here which does not have any constricting or widening regions or throttles with a comparatively local extension in the guidance of the designated heat transfer medium, in particular does not have a throttle with an orifice-like extension.

Instead, a temperature-control element for controlling the temperature of a traction battery is proposed, having:
a feed and a return for a heat transfer medium for connecting the temperature-control element to a temperature-control device,
at least two temperature-control zones through which a fluid can flow, wherein each temperature-control zone is fluidically connected to the feed via a feed channel and to the return via a return channel,
wherein the temperature-control element does not have a throttle arranged in the feed channel or in the return channel, in particular does not have a throttle with an orifice-like extension.

This makes it possible to significantly reduce the maximum designated flow velocities of the heat transfer medium within the temperature-control element, which can increase the service life of the temperature-control element because material erosion is reduced at the maximum flow velocity, and the noise level emanating from the designated flowing heat transfer medium can be reduced.

Furthermore, a temperature-control element is proposed, the guidance of the designated heat transfer medium of which is designed by first and second feed channels that preferably run at least partially parallel to one another and preferably are at least partially adjacent to one another, wherein a first feed channel is fluidically connected to a first temperature-control zone, and a second feed channel is fluidically connected to a second temperature-control zone. Furthermore, the temperature-control element proposed herein provides for a flow divider to be provided in the feed channel, which divides the feed channel into the first feed channel and the second feed channel.

Here, it can be provided for the feed channel immediately adjacent to the temperature-control zone to be open towards the temperature-control zone, so that a designated heat transfer medium can flow in a designated manner from this feed channel into the temperature-control zone over at least part of the temperature-control zone width, preferably over the entire temperature-control zone width.

The position of the flow divider can thus influence the distribution of the designated partial fluid volume flows of the heat transfer medium, which can flow in a designated manner through the first and second temperature-control zones. Furthermore, the geometry of the first feed channel and/or the geometry of the second feed channel can influence the pressure loss in the respective feed channel, which can also influence the respective pressure loss of the designated partial fluid volume flows of the heat transfer medium.

In other words, a temperature-control element is proposed the hydraulic balancing of which is achieved by the position of the flow divider in the feed channel and the geometry of the first feed channel and the geometry of the second feed channel, so that the temperature-control element can exhibit an essentially homogeneous temperature-control performance. Preferably, the first and/or the second feed channel extend with an essentially constant cross-section in their respective longitudinal extension direction.

The temperature-control zones can have a common return channel.

This advantageously makes it possible to achieve a temperature-control element the hydraulic balancing of which is comparatively less sensitive to manufacturing tolerances.

Furthermore, it can be advantageously achieved that the contact area of a battery module can correspond almost completely with the heat transfer medium in the vertical direction, even with a particularly high grade of packaging of a designated traction battery, whereby so-called hot spots can be avoided or at least reduced in their severity. Moreover, the space available for the cooling fins can be maximized, which can improve and/or homogenize the temperature-control performance of the temperature-control element. This also makes it possible to achieve a higher packing density of the designated traction battery.

The temperature-control element has a simplified design in at least two temperature-control zones, since, compared to the solution known in the prior art, only one temperature-control element is required for the entire traction battery, and not one temperature-control element for each battery module. This reduces manufacturing and assembly costs for the temperature control of a designated traction battery and avoids potential sources of leaks due to the reduced number of necessary fluid connections.

Overall, the temperature-control element proposed herein allows for a particularly homogeneous temperature control of a traction battery, while at the same time avoiding potential leaks within a designated traction battery housing and at the same time reducing demands upon the manufacturing tolerances of the temperature-control element, which can reduce manufacturing costs. Homogeneous temperature control can reduce the risk of thermal escalation of a battery module.

Optionally, the temperature-control element has at least three temperature-control zones through which a fluid can flow, wherein each temperature-control zone is fluidically connected to the feed via a feed channel and to the return via a return channel; and wherein at least a third temperature-control zone is fluidically connected to the first feed channel or to the second feed channel.

A temperature-control element is proposed herein which has at least three temperature-control zones through which a fluid can flow. Preferably, the first temperature-control zone is directly fluidically connected to the first feed channel, and the second temperature-control zone is preferably directly fluidically connected to the second feed channel. The third temperature-control zone can be directly fluidically connected to the first feed channel or at least directly or indirectly fluidically connected to the second feed channel.

According to an expedient embodiment, the temperature-control element has at least three temperature-control zones through which a fluid can flow, wherein each temperature-control zone is fluidically connected to the feed via a feed channel and to the return via a return channel; wherein the temperature-control element has a second flow divider arranged in the second feed channel, wherein the second flow divider divides the second feed channel into a third feed channel and a fourth feed channel; wherein at least one temperature-control zone is fluidically connected to the third feed channel; and wherein at least one temperature-control zone is fluidically connected to the fourth feed channel.

The temperature-control element proposed herein can, inter alia, be such that the first temperature-control zone is directly fluidically connected to the first feed channel, and the second temperature-control zone is directly fluidically connected to the third feed channel, and the third temperature-control zone is fluidically connected to the fourth feed channel.

Preferably, the third feed channel and the fourth feed channel run at least partially parallel to each other and are preferably at least partially adjacent to each other.

Optionally, the temperature-control element has at least four temperature-control zones through which a fluid can flow, wherein each temperature-control zone is fluidically connected to the feed via a feed channel and to the return via a return channel; and wherein at least a fourth temperature-control zone is fluidically connected to the first feed channel or to the second feed channel.

Preferably, the first temperature-control zone is directly fluidically connected to the first feed channel, and the second temperature-control zone is directly fluidically connected to the second feed channel. Furthermore, the third temperature-control zone and the fourth temperature-control zone are preferably fluidically connected to the first feed channel or the second feed channel, wherein the third temperature-control zone can also be directly fluidically connected to the first feed channel, and the fourth temperature-control zone can be directly fluidically connected to the second feed channel.

According to an optional embodiment, the temperature-control element has at least four temperature-control zones through which a fluid can flow, wherein each temperature-control zone is fluidically connected to the feed via a feed channel and to the return via a return channel; wherein the temperature-control element has a third flow divider arranged in the fourth feed channel, wherein the third flow divider divides the fourth feed channel into a fifth feed channel and a sixth feed channel; wherein at least one temperature-control zone is fluidically connected to the fifth feed channel; and wherein at least one temperature-control zone is fluidically connected to the sixth feed channel.

The temperature-control element proposed herein can, inter alia, be such that the first temperature-control zone is directly fluidically connected to the first feed channel, and the second temperature-control zone is directly fluidically connected to the third feed channel, and the third temperature-control zone is fluidically connected to the fifth feed channel, and the fourth temperature-control zone is directly fluidically connected to the sixth feed channel.

Preferably, the fifth feed channel and the sixth feed channel run at least partially parallel to each other and are preferably at least partially adjacent to each other.

Optionally, the temperature-control element has at least five temperature-control zones through which a fluid can flow, wherein each temperature-control zone is fluidically connected to the feed via a feed channel and to the return via a return channel; and wherein at least a fifth temperature-control zone is fluidically connected to the first feed channel or to the second feed channel.

According to an optional embodiment, the temperature-control element has at least five temperature-control zones through which a fluid can flow, wherein each temperature-control zone is fluidically connected to the feed via a feed channel and to the return via a return channel; wherein the temperature-control element has a fourth flow divider arranged in the sixth feed channel, wherein the fourth flow divider divides the sixth feed channel into a seventh feed channel and an eighth feed channel; wherein at least one temperature-control zone is fluidically connected to the seventh feed channel; and wherein at least one temperature-control zone is fluidically connected to the eighth feed channel.

The temperature-control element proposed herein can, inter alia, be such that the first temperature-control zone is directly fluidically connected to the first feed channel, and the second temperature-control zone is directly fluidically connected to the third feed channel, and the third temperature-control zone is fluidically connected to the fifth feed channel, and the fourth temperature-control zone is directly fluidically connected to the seventh feed channel, and the fifth temperature-control zone is directly fluidically connected to the eighth feed channel.

Preferably, the seventh feed channel and the eighth feed channel run at least partially parallel to each other and are preferably at least partially adjacent to each other.

According to a preferred embodiment, the temperature-control element has at least one flow inlet arranged in the return channel, wherein, at the flow inlet, a first return channel and a second return channel open into the return channel; wherein at least one temperature-control zone is fluidically connected to the first return channel; and wherein at least one temperature-control zone is fluidically connected to the second return channel.

In this regard, the following is explained conceptually:

A “flow inlet” is understood to mean a geometric structure which is configured to allow two fluid volume flows flowing towards the flow inlet, in particular two fluid volume flows of a heat transfer medium, to flow into one another at the flow inlet. Here, it is not necessary for one partial fluid volume flow to be larger than the other partial fluid volume flow. Preferably, a flow inlet is configured to allow a first partial fluid volume flow of the heat transfer medium flowing through a first return channel towards the flow inlet and a second partial fluid volume flow of the heat transfer medium flowing through a second return channel towards the flow inlet to flow into one another at the flow inlet, the flow inlet being, in particular, the first flow inlet, wherein they flow out together through the return of the temperature-control element.

The first temperature-control zone can be fluidically connected to the first return channel, and the second temperature-control zone can be fluidically connected to the second return channel.

A temperature-control element can have exactly one flow inlet, preferably exactly two flow inlets, exactly three flow inlets, exactly four flow inlets, or more than four flow inlets.

A temperature-control element is proposed herein, the guidance of the designated heat transfer medium of which is designed by first and second return channels which preferably run at least partially parallel to one another and are preferably at least partially adjacent to one another, wherein, at the flow inlet, the first return channel and the second return channel open into the return channel.

The position of the flow inlet can influence the respective pressure loss of the designated partial fluid volume flows of the heat transfer medium, which can flow in a designated manner through the first and second temperature-control zones. Furthermore, the geometry of the first return channel and/or the geometry of the second return channel can influence the pressure loss in the respective return channel, which can also influence the respective pressure loss of the designated partial fluid volume flows of the heat transfer medium.

In other words, a temperature-control element is proposed the hydraulic balancing of which is achieved by the position of the flow inlet in the return channel, the position of the flow divider in the feed channel, and the geometries of the first feed channel, the second feed channel, the first return channel, and the second return channel, so that the temperature-control element can exhibit an essentially homogeneous temperature-control performance. Preferably, the first and/or the second return channel extend with an essentially constant cross-section in their respective longitudinal extension direction.

This advantageously makes it possible to achieve a temperature-control element the hydraulic balancing of which is comparatively less sensitive to manufacturing tolerances.

Expediently, the temperature-control element has at least a second flow inlet arranged in the second return channel, wherein, at the second flow inlet, a third return channel and a fourth return channel open into the second return channel; wherein at least one temperature-control zone is fluidically connected to the third return channel; and wherein at least one temperature-control zone is fluidically connected to the fourth return channel.

The temperature-control element proposed herein can, inter alia, have three temperature-control zones, wherein the first temperature-control zone is directly fluidically connected to the first return channel, and the second temperature-control zone is directly fluidically connected to the third return channel, and the third temperature-control zone is fluidically connected to the fourth return channel.

Preferably, the third return channel and the fourth return channel run at least partially parallel to each other and are preferably at least partially adjacent to each other.

According to a second aspect of the invention, the object is achieved by a temperature-control element for controlling the temperature of a traction battery, having:
a feed and a return for a heat transfer medium for connecting the temperature-control element to a temperature-control device,
at least two temperature-control zones through which a fluid can flow, wherein each temperature-control zone is fluidically connected to the feed via a feed channel and to the return via a return channel,
wherein the temperature-control element has at least one flow inlet arranged in the return channel, wherein, at the flow inlet, a first return channel and a second return channel open into the return channel;
wherein at least a first temperature-control zone is fluidically connected to the first return channel; and
wherein at least one second temperature-control zone is fluidically connected to the second return channel.

A temperature-control element is proposed herein, the guidance of the designated heat transfer medium of which is designed by first and second return channels that preferably run at least partially parallel to one another and preferably are at least partially adjacent to one another, wherein a first return channel is fluidically connected to a first temperature-control zone, and a second return channel is fluidically connected to a second temperature-control zone. Furthermore, the temperature-control element proposed herein provides, at the flow inlet, for a first return channel and a second return channel to open into the return channel.

The position of the flow inlet can influence the respective pressure loss of the designated partial fluid volume flows of the heat transfer medium, which can flow in a designated manner through the first and second temperature-control zones. Furthermore, the geometry of the first return channel and/or the geometry of the second return channel can influence the pressure loss in the respective return channel, which can also influence the respective pressure loss of the designated partial fluid volume flows of the heat transfer medium.

In other words, a temperature-control element is proposed the hydraulic balancing of which is achieved by the position of the flow inlet in the return channel and the geometry of the first return channel and the geometry of the second return channel, so that the temperature-control element can exhibit an essentially homogeneous temperature-control performance. Preferably, the first and/or the second return channel extend with an essentially constant cross-section in their respective longitudinal extension direction.

This advantageously makes it possible to achieve a temperature-control element the hydraulic balancing of which is comparatively less sensitive to manufacturing tolerances.

Furthermore, it can be advantageously achieved that the contact area of a battery module can correspond almost completely with the heat transfer medium in the vertical direction, even with a particularly high grade of packaging of a designated traction battery, whereby so-called hot spots can be avoided or at least reduced in their severity. Moreover, the space available for the cooling fins can be maximized, which can improve and/or homogenize the temperature-control performance of the temperature-control element.

Overall, the temperature-control element proposed herein allows for a particularly homogeneous temperature control of a traction battery, while at the same time reducing the demands upon the manufacturing tolerances of the temperature-control element. Homogeneous temperature control can reduce the risk of thermal escalation of a battery module.

The first temperature-control zone can be fluidically connected to the first return channel, and the second temperature-control zone can be fluidically connected to the second return channel.

The temperature-control zones can have a common feed channel.

Advantageously, the temperature-control element proposed herein can ensure that the pressure losses dimensioning the designated partial fluid volume flow through a respective temperature-control zone can be brought about upstream and/or downstream of a temperature-control element. It is also conceivable that the dimensioning pressure losses for the individual temperature-control zones can be brought about alternately upstream and downstream of the respective temperature-control elements. This makes it possible, in particular, to increase the packing density of the designated traction battery.

According to a preferred embodiment, the temperature-control element has at least three temperature-control zones through which a fluid can flow, wherein each temperature-control zone is fluidically connected to the feed via a feed channel and to the return via a return channel; and wherein at least a third temperature-control zone is fluidically connected to the first return channel or to the second return channel.

According to an optional embodiment, the temperature-control element has at least three temperature-control zones through which a fluid can flow, wherein each temperature-control zone is fluidically connected to the feed via a feed channel and to the return via a return channel; wherein the temperature-control element has a second flow inlet arranged in the second return channel, wherein, at the second flow inlet, a third return channel and a fourth return channel open into the second return channel; wherein at least one temperature-control zone is fluidically connected to the third return channel; and wherein at least one temperature-control zone is fluidically connected to the fourth return channel.

The temperature-control element proposed herein can, inter alia, be such that the first temperature-control zone is directly fluidically connected to the first return channel, and the second temperature-control zone is directly fluidically connected to the third return channel, and the third temperature-control zone is fluidically connected to the fourth return channel.

Preferably, the third return channel and the fourth return channel run at least partially parallel to each other and are preferably at least partially adjacent to each other.

According to an expedient embodiment, the temperature-control element has at least four temperature-control zones through which a fluid can flow, wherein each temperature-control zone is fluidically connected to the feed via a feed channel and to the return via a return channel; and wherein at least a fourth temperature-control zone is fluidically connected to the first return channel or to the second return channel.

According to an optional embodiment, the temperature-control element has at least four temperature-control zones through which a fluid can flow, wherein each temperature-control zone is fluidically connected to the feed via a feed channel and to the return via a return channel; wherein the temperature-control element has a third flow inlet arranged in the fourth return channel, wherein, at the third flow inlet, a fifth return channel and a sixth return channel open into the fourth return channel; wherein at least one temperature-control zone is fluidically connected to the fifth return channel; and wherein at least one temperature-control zone is fluidically connected to the sixth return channel.

The temperature-control element proposed herein can, inter alia, be such that the first temperature-control zone is directly fluidically connected to the first return channel, and the second temperature-control zone is directly fluidically connected to the third return channel, and the third temperature-control zone is fluidically connected to the fifth return channel, and the fourth temperature-control zone is directly fluidically connected to the sixth return channel.

Preferably, the fifth return channel and the sixth return channel run at least partially parallel to each other and are preferably at least partially adjacent to each other.

According to an expedient embodiment, the temperature-control element has at least five temperature-control zones through which a fluid can flow, wherein each temperature-control zone is fluidically connected to the feed via a feed channel and to the return via a return channel; and wherein at least a fifth temperature-control zone is fluidically connected to the first return channel or to the second return channel.

According to an optional embodiment, the temperature-control element has at least five temperature-control zones through which a fluid can flow, wherein each temperature-control zone is fluidically connected to the feed via a feed channel and to the return via a return channel; wherein the temperature-control element has a fourth flow inlet arranged in the sixth return channel, wherein, at the fourth flow inlet, a seventh return channel and an eighth return channel open into the sixth return channel; wherein at least one temperature-control zone is fluidically connected to the seventh return channel; and wherein at least one temperature-control zone is fluidically connected to the eighth return channel.

The temperature-control element proposed herein can, inter alia, be such that the first temperature-control zone is directly fluidically connected to the first return channel, and the second temperature-control zone is directly fluidically connected to the third return channel, and the third temperature-control zone is fluidically connected to the fifth return channel, and the fourth temperature-control zone is directly fluidically connected to the seventh return channel, and the fifth temperature-control zone is directly fluidically connected to the eighth return channel.

Preferably, the seventh return channel and the eighth return channel run at least partially parallel to each other and are preferably at least partially adjacent to each other.

According to a particularly preferred embodiment, a flow divider extends at least in regions as a wall between the divided feed channels, in particular as a dividing web-shaped wall.

In this regard, the following is explained conceptually:

A “wall” is understood to mean a wall-shaped geometric separation between adjacent feed channels and/or adjacent return channels. Preferably, a wall has an essentially constant wall thickness in the direction of extension of the wall.

A “dividing web-shaped wall” is understood to mean a web-shaped wall. Preferably, the thickness of the dividing web-shaped wall is less than the height of the dividing web-shaped wall. However, a dividing web-shaped wall can also be understood to mean a wall the thickness of which is greater than its height.

With the wall, it can be achieved that the designated contact area of a battery module can correspond almost completely with the heat transfer medium in the vertical direction, even with a particularly high grade of packaging of a designated traction battery, whereby so-called hot spots can be avoided or at least reduced in their severity. Furthermore, this can lead to an improvement in the packing density of the designated traction battery.

According to an expedient embodiment, a flow divider extends as a wall between the divided feed channels at least over a temperature-control zone width.

In this regard, the following is explained conceptually: A temperature-control zone is a flat structure having a length, a width, and a height, wherein the width of the temperature-control zone is smaller than the length of the temperature-control zone and wherein the heat transfer medium flows in a designated manner in the longitudinal direction through the temperature-control zone. A “temperature-control zone width” is understood to mean the width of a temperature-control zone.

It is proposed herein that a flow divider between adjacent feed channels extend at least over the width of a temperature-control zone. Here, it can be provided for the feed channel immediately adjacent to the temperature-control zone to be open towards the temperature-control zone, so that a designated heat transfer medium can flow in a designated manner from this feed channel into the temperature-control zone over at least part of the temperature-control zone width, preferably over the entire temperature-control zone width.

Particularly preferably, a flow inlet extends at least in regions as a wall between the incoming return channels, in particular as a dividing web-shaped wall.

Expediently, a flow inlet extends as a wall between the incoming return channels at least over the width of a temperature-control zone.

According to a preferred embodiment, a ratio of free cross-sections of feed channels, arranged immediately adjacent to a flow divider, at a location on both sides transverse to a flow divider with a tolerance deviation of less than or equal to 15%, preferably with a tolerance deviation of less than or equal to 10% and particularly preferably with a tolerance deviation of less than or equal to 5%, corresponds to the ratio of the temperature-control zones that are at least indirectly fluidically connected to the feed channels arranged immediately adjacent.

In this regard, the following is explained conceptually: A “free cross-section” of a feed channel and/or of a return channel is understood to mean the cross-section of the feed channel and/or of the return channel through which the heat transfer medium can freely flow in the designated flow direction.

Furthermore, the tolerance deviation is advantageously less than or equal to 4%, preferably the tolerance deviation is less than or equal to 2.5%, and particularly preferably the tolerance deviation is less than or equal to 1%.

Preferably, a ratio of free cross-sections of return channels arranged immediately adjacent to a flow inlet at a location on both sides transverse to a flow inlet with a tolerance deviation of less than or equal to 15%, preferably with a tolerance deviation of less than or equal to 10%, and particularly preferably with a tolerance deviation of less than or equal to 5%, corresponds to the ratio of the temperature-control zones that are at least indirectly fluidically connected to the return channels arranged immediately adjacent.

Furthermore, the tolerance deviation is advantageously less than or equal to 4%, preferably the tolerance deviation is less than or equal to 2.5%, and particularly preferably the tolerance deviation is less than or equal to 1%.

A temperature-control zone is expediently configured to control the temperature of a designated battery module.

It is proposed herein for the temperature-control element to be designed as a function of the other designated components of a traction battery such that exactly one corresponding battery module is assigned to a temperature-control zone. In other words, the size and/or position of the temperature-control zone is designed so that it optimally matches the designated corresponding battery module and its size.

According to a particularly expedient embodiment, a temperature-control zone has one or more cooling fins.

In this regard, the following is explained conceptually:

A “cooling fin” is understood to mean a geometric element within a temperature-control zone which is configured to increase the contact surface between the temperature-control zone and the designated heat transfer medium. The increase in the contact surface can be achieved in particular by the rib-like design of a cooling fin. The maximum temperature-control performance of a temperature-control zone can be increased by a larger contact surface.

A cooling fin can be configured to increase the degree of turbulence of the heat transfer medium, which can also increase the maximum temperature-control performance of a temperature-control zone.

Preferably, a cooling fin is connected to a temperature-control element base and/or a temperature-control element cover. Preferably, a cooling fin can be inserted between the temperature-control element base and the temperature-control element cover.

A cooling fin can also have a ribbed surface in addition to its ribbed shape.

A cooling fin can have a wavy cross-section.

Preferably, a base area of a temperature-control zone having one or more cooling fins corresponds to greater than or equal to 85% of a contact area of a battery module that is designated to be temperature-controlled, preferably greater than or equal to 90%, and particularly preferably greater than or equal to 95%.

In this regard, the following is explained conceptually:

The term “base area” of the temperature-control zone refers to the outer surface of a temperature-control zone that is designated to be operatively connected to a battery module. Preferably, the base area of the temperature-control zone corresponds to the product of the width and length of the temperature-control zone.

Preferably, the base area corresponds to the cross-sectional area, projected in the direction of the designated battery module, of the temperature-control element having a cooling fin.

A “contact area” of a battery module is understood to mean the area on which a battery module in the designated installation position stands on an essentially flat surface, i.e., is in contact with the surface.

Advantageously, this can improve temperature control homogeneity.

Optionally, at least one feed channel and/or at least one return channel has a throttle.

In this regard, the following is explained conceptually: A “throttle” is understood to mean a geometric region of a feed channel or of a return channel which, in the designated flow direction of the heat transfer medium, initially has a converging free cross-section and, after an extreme point having a nominal width of the throttle, has a diverging free cross-section.

The temperature-control element is expediently made of a metallic material, in particular aluminum.

Using a metallic material can result in a particularly advantageously high thermal conductivity coefficient.

According to an expedient embodiment, a temperature-control zone has an orifice at its inlet and/or at its outlet, in particular an orifice with a cross-section that varies with the temperature-control zone width, in particular an orifice with a cross-section that extends in a wedge shape over the temperature-control zone width.

In this regard, the following is explained conceptually:

An “orifice” is understood to mean a constriction of the free cross-section of a temperature-control zone at its inlet and/or outlet, wherein the local constriction of the free cross-section can vary across the temperature-control zone width. In particular, the orifice can extend in a wedge shape over the width of a temperature-control zone, so that the free cross-section of the temperature-control zone in this case is trapezoidal or triangular at its inlet and/or at its outlet.

Advantageously, the pressure loss of a flow tube limited to a width segment of a temperature-control zone can be adjusted via the orifice proposed herein such that the designated flow velocity of the heat transfer medium is essentially constant across the temperature-control zone width. In particular, the diversion of the designated flow of the heat transfer medium from the corresponding feed channel to the temperature-control zone and/or the diversion from the temperature-control zone to the designated return channel can lead to a non-homogeneous distribution of the designated flow velocity in the temperature-control zone, and thus to a non-homogeneous temperature control of the designated battery module. These possible effects can be compensated for with the orifice suggested herein.

It should be expressly noted that the subject matter of the second aspect can advantageously be combined with the subject matter of the preceding aspect of the invention, both individually or cumulatively in any combination.

According to a third aspect of the invention, the object is achieved by a traction battery having a temperature-control element according to the first aspect of the invention and/or by a temperature-control element according to the second aspect of the invention.

It should be understood that the advantages of a temperature-control element according to the first aspect of the invention and/or of a temperature-control element according to the second aspect of the invention, as described herein, extend directly to a traction battery having a temperature-control element according to the first aspect of the invention and a temperature-control element according to the second aspect of the invention.

It should be expressly noted that the subject matter of the third aspect can advantageously be combined with the subject matter of the preceding aspects of the invention, both individually or cumulatively in any combination.

Further advantages, details, and features of the invention can be found below in the described exemplary embodiments. In the figures, in detail:

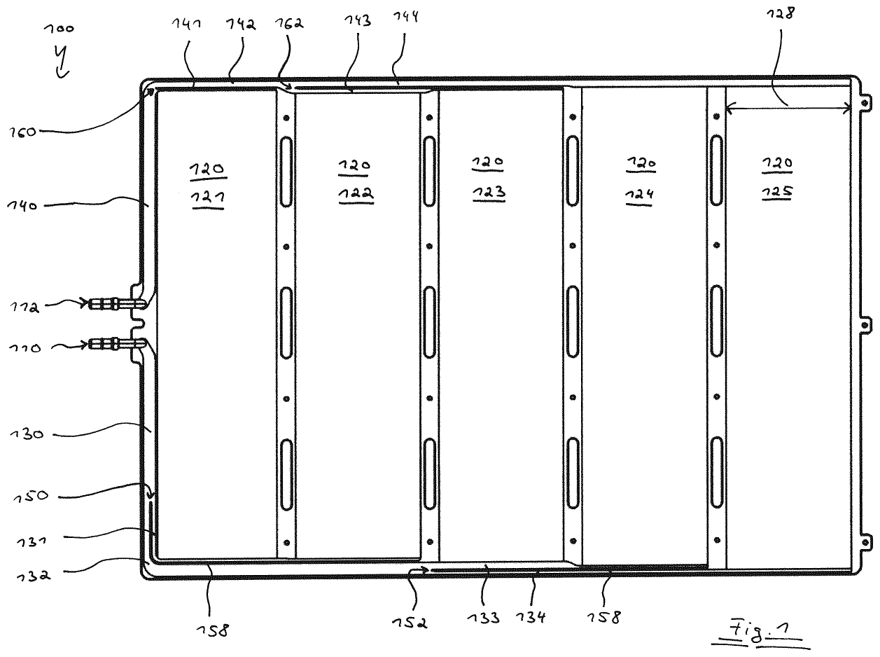

FIG. 1 schematically shows an embodiment of a temperature-control element, wherein a temperature-control element cover is not shown, and thus the interior of the temperature-control element is visible; and

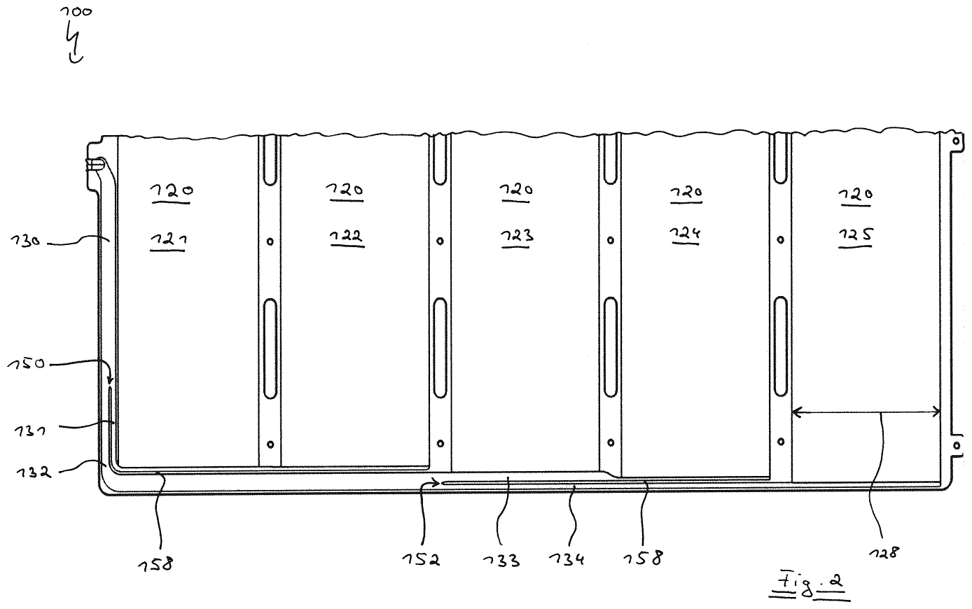

FIG. 2 schematically shows a first detail view of the embodiment of a temperature-control element according to FIG. 1;

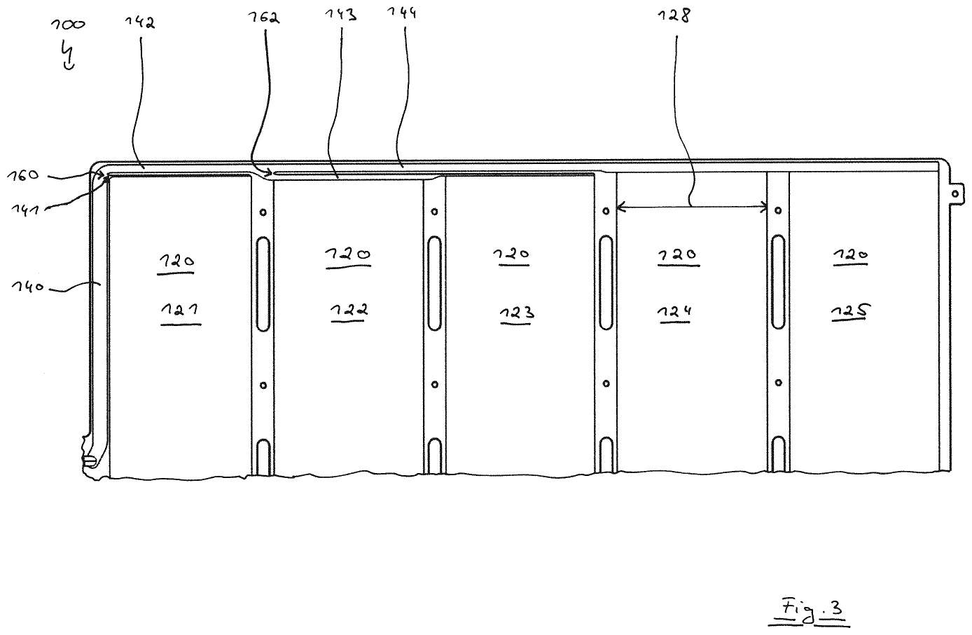

FIG. 3 schematically shows a second detail view of the embodiment of a temperature-control element according to FIG. 1; and

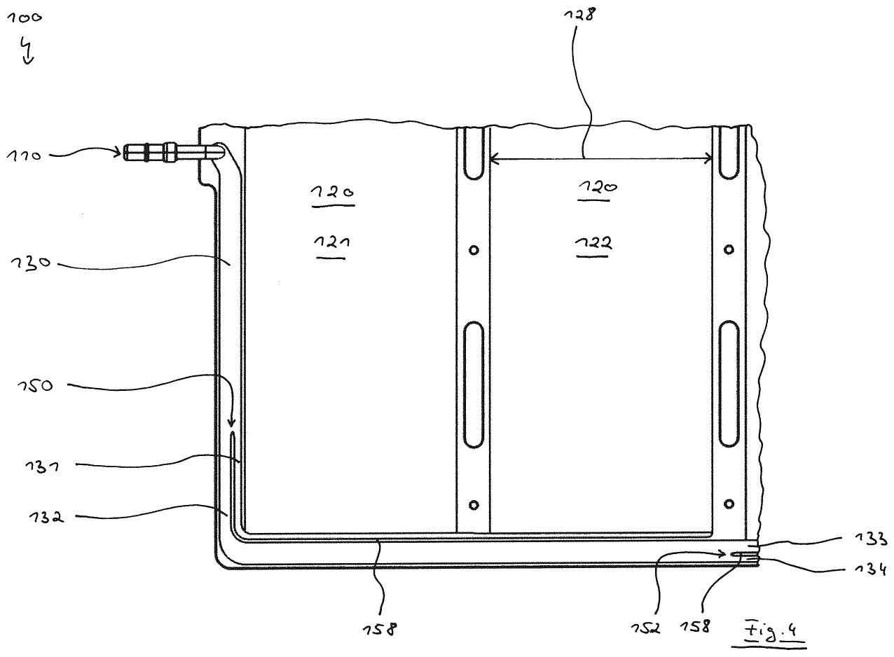

FIG. 4 schematically shows a third detail view of the embodiment of a temperature-control element according to FIG. 1.

In the following description, the same reference signs denote the same components or features; in the interest of avoiding repetition, a description of a component made with reference to one drawing also applies to the other drawings. Furthermore, individual features that have been described in connection with one embodiment can also be used separately in other embodiments.

The temperature-control element 100 according to FIG. 1 and the detail views according to FIG. 2, FIG. 3, and FIG. 4 have a total of five temperature-control zones 120 through which a fluid can flow, viz., a first temperature-control zone 121, a second temperature-control zone 122, a third temperature-control zone 123, a fourth temperature-control zone 124, and a fifth temperature-control zone 125.

The temperature-control element 100 has a feed 110 and a return 112 for a designated heat transfer medium (not shown) for connecting the temperature-control element 100 to a temperature-control device (not shown).

Each temperature-control zone 120 is at least indirectly fluidically connected to the feed 110 via a feed channel 130 and to the return 112 via a return channel 140.

The temperature-control element 100 has a flow divider 150 which is arranged in the feed channel 130 and divides the feed channel 130 into a first feed channel 131 and a second feed channel 132. The first temperature-control zone 121 and the second temperature-control zone 122 are directly fluidically connected to the first feed channel 131.

The temperature-control element 100 also has a second flow divider 152 which is arranged in the second feed channel 132 and divides the second feed channel 132 into a third feed channel 133 and a fourth feed channel 134. The third temperature-control zone 123 and the fourth temperature-control zone 124 are directly fluidically connected to the third feed channel 133.

The fifth temperature-control zone 125 is directly fluidically connected to the fourth feed channel 134.

A temperature-control zone 120 can have cooling fins (not shown).

The temperature-control element 100 has at least one flow inlet 160 arranged in the return channel 140, wherein, at the flow inlet 160, a first return channel 141 and a second return channel 142 open into the return channel 140.

The first temperature-control zone 121 is directly fluidically connected to the first return channel 141.

The temperature-control element 100 also has a second flow inlet 162 arranged in the second return channel 142, wherein, at the second flow inlet 162, a third return channel 143 and a fourth return channel 144 open into the second return channel 142.

The second temperature-control zone 122 and the third temperature-control zone 123 are directly fluidically connected to the third return channel 143. The fourth temperature-control zone 124 and the fifth temperature-control zone 125 are directly fluidically connected to the fourth return channel 144.

The flow divider 150 extends at least in regions as a wall (not designated) over at least one temperature-control zone width 128 between the first feed channel 131 and the second feed channel 132. The second flow divider 152 extends at least in regions as a wall (not designated) over at least one temperature-control zone width 128 between the third feed channel 133 and the fourth feed channel 134.

The flow inlet 160 extends at least in regions as a wall (not designated) over at least one temperature-control zone width 128 between the first return channel 141 and the second return channel 142. The second flow inlet 162 extends at least in regions as a wall (not designated) over at least one temperature-control zone width 128 between the third return channel 143 and the fourth return channel 144.

Further details can be found in the detail views of the embodiment according to FIG. 1 in FIG. 2, FIG. 3, and/or FIG. 4.

### LIST OF REFERENCE SIGNS

100 temperature-control element
110 feed
112 return
120 temperature-control zone
121 first temperature-control zone
122 second temperature-control zone
123 third temperature-control zone
124 fourth temperature-control zone
125 fifth temperature-control zone
128 temperature-control zone width
130 feed channel
131 first feed channel
132 second feed channel
133 third feed channel
134 fourth feed channel
135 fifth feed channel
136 sixth feed channel
140 return channel
141 first return channel
142 second return channel
143 third return channel
144 fourth return channel
150 flow divider
152 second flow divider
153 third flow divider
158 wall
160 flow inlet
162 second flow inlet
170 cooling fin

1. A temperature-control element for controlling a temperature of a traction battery having a feed and a return for a heat transfer medium for connecting the temperature-control element to a temperature-control device, and at least two temperature-control zones through which a fluid can flow, wherein each temperature-control zone is fluidically connected to the feed via a feed channel and to the return via a return channel, characterized by the following features: the temperature-control element comprising:
a flow divider which is arranged in the feed channel and divides the feed channel into a first feed channel and a second feed channel,
wherein a first temperature-control zone of the at least two temperature-control zones is fluidically connected to the first feed channel, and
wherein a second temperature-control zone of the at least two temperature-control zones is fluidically connected to the second feed channel.

2. The temperature-control element according to claim 1, wherein a third temperature-control zone of the at least two temperature-control zones is fluidically connected to the first feed channel or to the second feed channel.

3. The temperature-control element according to claim 2, wherein:
the flow divider is a first flow divider;
the temperature-control element further comprises a second flow divider arranged in the second feed channel such that the second flow divider divides the second feed channel into a third feed channel and a fourth feed channel;
at least one temperature-control zone of the at least two temperature-control zones is fluidically connected to the third feed channel; and
at least one temperature-control zone of the at least two temperature-control zones is fluidically connected to the fourth feed channel.

4. The temperature-control element according to claim 1, wherein:
the temperature-control element further comprises a flow inlet arranged in the return channel;
at the flow inlet, a first return channel and a second return channel open into the return channel;
at least one temperature-control zone of the at least two temperature-control zones is fluidically connected to the first return channel; and
at least one temperature-control zone of the at least two temperature-control zones is fluidically connected to the second return channel.

5. The temperature-control element according to claim 4, wherein:
the flow inlet is a first flow inlet;
the temperature-control element further comprises a second flow inlet arranged in the second return channel;
at the second flow inlet, a third return channel and a fourth return channel open into the second return channel;
at least one temperature-control zone of the at least two temperature-control zones is fluidically connected to the third return channel; and
at least one temperature-control zone of the at least two temperature-control zones is fluidically connected to the fourth return channel.

6. A temperature-control element for controlling a temperature of a traction battery having a feed and a return for a heat transfer medium for connecting the temperature-control element to a temperature-control device, and at least two temperature-control zones through which a fluid can flow, wherein each temperature-control zone is fluidically connected to the feed via a feed channel and to the return via a return channel, the temperature-control element comprising:
a flow inlet arranged in the return channel such that, at the flow inlet, a first return channel and a second return channel open into the return channel;
wherein a first temperature-control zone of the at least two temperature-control zones is fluidically connected to the first return channel; and
wherein a second temperature-control zone of the at least two temperature-control zones is fluidically connected to the second return channel.

7. The temperature-control element according to claim 6, wherein a third temperature-control zone of the at least two temperature-control zones is fluidically connected to the first return channel or to the second return channel.

8. The temperature-control element according to claim 7, wherein:
the flow inlet is a first flow inlet;
the temperature-control element further comprises a second flow inlet arranged in the second return channel;
at the second flow inlet, a third return channel and a fourth return channel open into the second return channel;
at least one temperature-control zone of the at least two temperature-control zones is fluidically connected to the third return channel; and
at least one temperature-control zone of the at least two temperature-control zones is fluidically connected to the fourth return channel.

9. The temperature-control element according to claim 6, further comprising a flow divider that extends at least in regions as a wall between divided feed channels as a dividing web-shaped wall.

10. The temperature-control element according to claim 6, wherein the flow inlet extends at least in regions as a wall between incoming divided return channels as a dividing web-shaped wall.

11. The temperature-control element according to claim 6, wherein at least one temperature-control zone of the at least two temperature-control zones has one or more cooling fins.

12. The temperature-control element according to claim 11, wherein a base area of the at least one temperature-control zone corresponds to greater than or equal to 85% of a contact area of a battery module that is designated to be temperature-controlled.

13. The temperature-control element according to claim 6, wherein the temperature-control element is made of a metallic material.

14. The temperature-control element according to claim 6, wherein a temperature-control zone of the at least two temperature-control zones has an orifice at an inlet thereof and/or at an outlet thereof,
wherein the orifice has a cross-section that varies with a temperature-control zone width and extends in a wedge shape over the temperature-control zone width.

15. A traction battery having a temperature-control element according to claim 1.
